(19) United States
(12) Patent Application Publication
(10) Pub. No.: US 2012/0041871 A1
(43) Pub. Date: Feb. 16, 2012

(54) CONTROLLING CONSUMPTION OF A SHARED SERVICE

(75) Inventors: David M. Sell, Honeywell, NJ (US); Lior Auslander, Voorhess, NJ (US); Kadia S. Hemlata, Voorhees, NJ (US); Matsliach Gabriel, Voorhees, NJ (US); Porter R. Wesley, Medford, NJ (US)

(73) Assignee: Comverse, Inc.

(21) Appl. No.: 13/262,161

(22) PCT Filed: Apr. 30, 2009
(86) PCT No.: PCT/US09/02646

§ 371 Date: Sep. 29, 2011

(51) Int. Cl. G06Q 40/02

(52) U.S. Cl. 705/39

(57) ABSTRACT

There is provided a method that includes (a) obtaining a first balance indicative of a first available funding for a service for a subscriber, in which the first balance may be consumed by the subscriber; (b) obtaining a second balance indicative of a second available funding for the service, in which the second balance may be consumed by the subscriber; (c) determining whether both of the first and second balances are sufficient to provide for the service; and (d) issuing a communication to a device to permit usage of the service by the subscriber, if both of the first and second balances are sufficient to provide for the service.

### BACKGROUND OF THE INVENTION

1. Field of the Invention

The present disclosure relates to a technique for controlling consumption of a shared service, such as a mobile telephone service being provided to a group of subscribers.

2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

An element of many billing packages offered by providers of a service, for example, a service provider for mobile telephone communication, is the notion of sharing. Whether it is a common pool of minutes shared by a family mobile plan, or a department's data services budget which can be shared amongst its members, sharing allows a service provider to sell more to larger groups, and allows members of these groups to used their shared funds efficiently.

With sharing comes the necessity for control. A parent may not want one child using all the minutes, just as a department manager may not want all money for Internet services going to one salesperson.

The present document discloses a technique for controlling consumption of a shared service.

### SUMMARY OF THE INVENTION

There is provided a method that includes (a) obtaining a first balance indicative of a first available funding for a service for a subscriber, in which the first balance may be consumed by the subscriber; (b) obtaining a second balance indicative of a second available funding for the service, in which the second balance may be consumed by the subscriber; (c) determining whether both of the first and second balances are sufficient to provide for the service; and (d) issuing a communication to a device to permit usage of the service by the subscriber, if both of the first and second balances are sufficient to provide for the service.

### BRIEF DESCRIPTION OF THE DRAWINGS

FIG. 1 is a block diagram of a configuration of balances being shared amongst subscribers within the account.

FIG. 2 is a block diagram of a configuration of balances being evaluated by a rating process.

FIG. 3 is block diagram of a configuration of balances, and shows a further illustration of a process for rating the balances.

FIG. 4 is a block diagram of a configuration of balances involving a plurality of accounts.

FIG. 5 is a block diagram of a configuration of balances associated with a system that is outside of a domain of a service provider.

FIG. 6 is a block diagram of a configuration of balances in which a shadow balance is associated with a plurality of real balances in different accounts.

FIG. 7 is a block diagram of a communication system that includes a rating server for administrating shadow balances.

FIG. 8 is a block diagram of the rating server of FIG. 7.

A component or a feature that is common to more than one drawing is indicated with the same reference number in each of the drawings.

### DESCRIPTION OF THE INVENTION

The present description introduces a concept referred to herein as a “shadow balance.” A shadow balance is a specific type of balance defined for the purpose of controlling consumption of funds from another source in a controlled and limited fashion. In more detail, shadow balances are a mechanism by which a source rating entity (e.g., a subscriber) can use the funds of another entity for purposes of pricing, charging, promotions and authorization. This is achieved via a “virtual” balance that is based on one or more target balances from different entities, as well as information from the source object itself. The actual value of the virtual balance is derived based on business logic.

At the end of the present description, there is a table, namely Table 1, that contains definitions of some other terms.

A risk associated with sharing a balance in an account is that the shared balance may be over-shared. That is, parties that are sharing the balance may collectively attempt to consume more of the balance than is available for consumption. In a technique for managing this risk, the use of funds from a shadow balance implicitly considers the available funds of the associated account level balance, and prohibits a subscriber with a shadow balance from spending more than the account has in a real balance. The relationship between the shadow balance and the real balance is described below in greater detail.

The present document describes a capability for both guaranteed funds sharing and spending control using the concept of shadow balances. The useful abstraction of a shadow balance allows for simplified rating calculations while providing subscribers with a common pool of funds for use, and control over how much of the common pool each subscriber can spend.

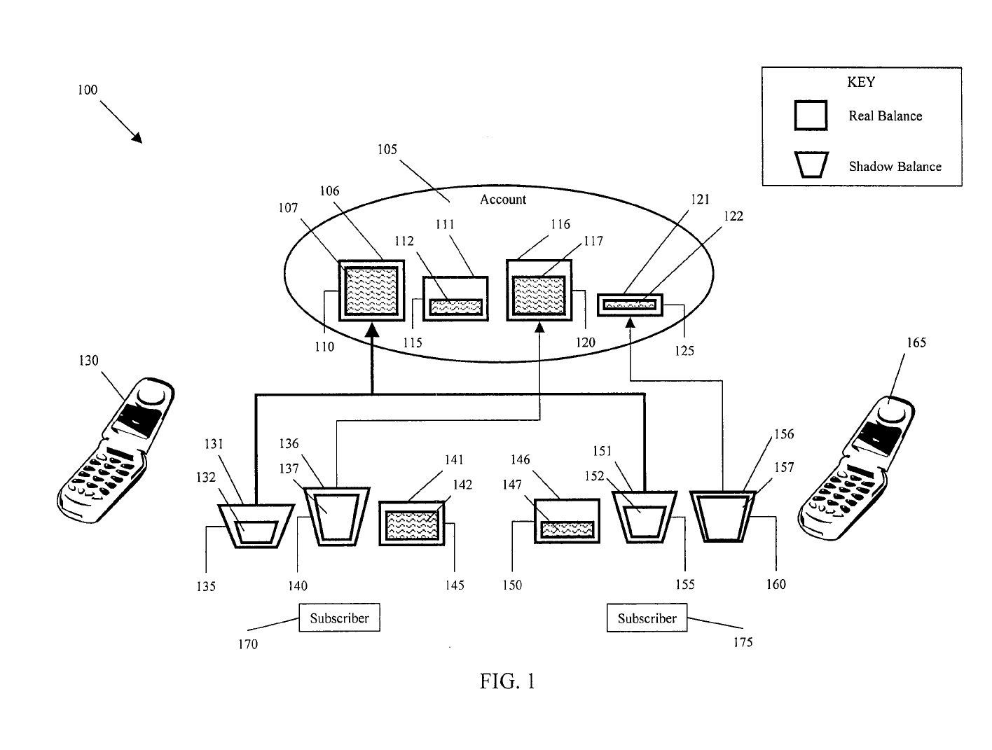

FIG. 1 is a block diagram of a sample configuration of balances, designated as configuration 100, associated with an account 105. Account 105 is setup to provide mobile telephone service for two subscribers, namely a subscriber 170 and a subscriber 175. Subscriber 170 uses a telephone 130, and subscriber 175 uses a telephone 165. While this example considers mobile service, any type of service could be provided.

There are two types of balances in configuration 100, namely real balances (denoted by the filled rectangular shapes) and shadow balances (denoted by the open trapezoidal shapes). The size of each rectangle or trapezoid is indicative of its quantity, i.e., a larger size represents a greater quantity than a smaller size. It may help to think of the shapes as glasses or buckets that hold some quantity of liquid (i.e., funds). Since only the real balances reflect actual funds, they are depicted as “filled,” while the shadow balances, which only control how much of a real balance can be spent, are depicted as open containers of various capacities. Only in the virtual model when the balances are algorithmically combined do we have the notion of a “filled” virtual balance.

Account 105 has four real balances 110, 115, 120 and 125. Subscriber 170 has two shadow balances 135, 140, and one real balance 145. Subscriber 175 also has one real balance 150, and two shadow balances 155, 160.

Real balances 110, 115, 120, 125, 145 and 150 are “real” in the sense that they have actual currency (or some other appropriate unit) associated with them, e.g., monetary allocations from prepaid recharge cards. It is also possible to have credit balances, which represent limits against funds that will be invoiced at a later time.

Real balance 110 has a maximum 106 (represented by an outer rectangle) and an available balance amount 107 (represented by a patterned inner rectangle). Maximum 106 is a service provider defined configuration that sets a limit on valid values for real balance 110. Maximum 106 represents the maximum amount of funds that real balance 110 can hold. For example, maximum 106 may indicate that real balance 110 may not be allowed to hold more than $500. Available balance amount 107 indicates a quantity of real balance 110 that is available for consumption. Typically, real balances in prepaid systems are increased in value by funding, e.g., recharge, and decreased in value by usage. So, an available balance amount 107 of $10.83 indicates that an additional $10.83 of usage charges may be consumed from real balance 110, at which point balance 110 is exhausted and cannot be used to pay for usage.

Each real balance, similarly to real balance 110, has a maximum and an available balance amount. Real balance 1115 has a maximum 111 and an available balance amount 112. Real balance 120 has a maximum 116 and an available balance amount 117. Real balance 125 has a maximum 121 and an available balance amount 122. Real balance 145 has a maximum 141 and an available balance amount 142. Real balance 150 has a maximum 146 and an available balance amount 147.

The different maxima of the real balances may reflect the fact that they are different units, i.e., a bytes balance would have a higher maximum than a ringtones balance.

Shadow balance 135 has a limit 131 (represented by an outer trapezoid) and an available balance amount 132 (represented by an inner trapezoid). Limit 131 defines a maximum amount of real balance 110 that subscriber 170 can use in any particular period. Available balance amount 132 indicates a quantity of shadow balance 135 that is currently available.

Each shadow balance, similarly to shadow balance 135, has a limit and an available balance amount. Shadow balance 140 has a limit 136 and an available balance amount 137. Shadow balance 155 has a limit 151 and an available balance amount 152. Shadow balance 160 has a limit 156 and an available balance amount 157.

As mentioned above, a shadow balance is for the purpose of controlling the consumption of funds from another source. Accordingly, each shadow balance is associated with a real balance at the account level. Shadow balances 135 and 155 are associated with real balance 110. Shadow balance 140 is associated with real balance 120. Shadow balance 160 is associated with real balance 125.

For example, assume that real balance 110 and shadow balance 135 represent a number of minutes of broadband usage. If subscriber 170 uses two minutes of broadband service, two minutes will be deducted from each of real balance 110 and shadow balance 135. The two minutes from real balance 110 represents two minutes that account 105 is permitted to consume (by either of subscriber 170 or subscriber 175), and the two minutes from shadow balance 135 represents, i.e., shadows, the two minutes that subscriber 170 is consuming from real balance 110.

By having shadow balances 135 and 155 associated with real balance 110, subscribers 170 and 175 are both able to consume funds from real balance 110. In other words, subscribers 170 and 175 are sharing real balance 110 from account 105, and as such, real balance 110 may be consumed by either of subscriber 170 or subscriber 175. Shadow balance 135 is for controlling subscriber 170's consumption of funds from real balance 110, and shadow balance 155 is for controlling subscriber 175's consumption of funds from real balance 110.

Note that none of shadow balances 135, 140, 155 or 160 has a particular unit. Instead, the unit type of a shadow balance is defined by its association with a real balance. That is, a shadow balance takes on the unit type of the real balance with which the shadow balance is associated. For example, if real balance 110 is in units of dollars, then shadow balances 135 and 155 will be in units of dollars. Balances may be designated in any desired unit, for example, currency, bytes, short message service (SMS) messages, or tokens.

The associations between shadow balances and real balances can be pre-defined by a provider of the mobile phone service, or can be customized on a case-by-case basis by a service representative or through customer self-care, e.g., an Internet web page. For example, assume that shadow balance 135 represents a number of minutes of broadband usage, shadow balance 140 represents a quantity of SMS messages, and real balance 145 represents a number of minutes of telephone usage. The quantities in each of shadow balance 135, shadow balance 140 and real balance 145 can be initialized at the beginning of each month, in accordance with a service agreement. Available balance amounts 132 and 137 are initially set to values of limits 131 and 136 respectively, and are reset to these values at the beginning of each new period. As with real balances, shadow balances typically start with a high value and then decrease as they are consumed, i.e., the available balance value reflects a remaining amount.

For example, consider that shadow balances 135 and 155 have monthly periods. This means that at the beginning of each month, available balance amounts 132 and 152 are reset to their respective limits 131 and 151. In this example, assume that available balance amount 137 was $0.80 before the reset, and $15 after. By resetting available balance amounts 137 and 152, subscribers 170 and 175 are again able to use their full allocations of real balance 110. Accordingly, subscriber 170 is allowed to consume up to $15/month from real balance 110. Prior to the reset, subscriber 170 only had $0.80 remaining of their $15 from May, and after the reset subscriber 170 has a new $15/month allocation for June. Real balance 110 itself is not cyclical in nature and is not reset; real balance 110 is replenished only by voucher recharge or other payment methods as needed, and these methods are not discussed here or relevant to the stated invention. When placing a call, both real balance 110 and available balance amount 137 are both deducted by the charge amount. Continuing the example, subscriber 170 places a call on June 1; the charge for the call is $2.50. Assuming funds in balance 110 are available, both real balance 110 and available balance amount 137 are deducted by $2.50. Limit 131 remains $15, as this is part of the configuration, not dynamic running balance information.

A key aspect of the concept of shadow balances is the introduction of control into the sharing of real balances. This control is achieved by configuring each subscriber's shadow balances with limits. Each limit represents the maximum amount of a shared real balance a subscriber can use in any particular period. For example, recall that shadow balance 135 has limit 131. Assume that limit 131 is set to $15/month. When the limit of $15 is reached, shadow balance 135 can no longer be used to fund activities. The service provider and the customers themselves have the ability to define different limit values for each shadow balance for each subscriber. This permits such scenarios as parents being able to spend $50/month of a shared family balance, but the children only being able to spend $20/month. In addition, the service provider can define various periods (e.g., weekly, monthly), as well as restrict which activities can be paid off with a shadow balance.

As mentioned above, subscriber 170 has two shadow balances 135, 140, and one real balance 145. Shadow balance 135 has a small limit, i.e., limit 131, relative to limit 136 of shadow balance 140. The relative sizes of available balance amount 132 and limit 131 indicate that for shadow balance 135, subscriber 170 has consumed about half of limit 131. The relative sizes of available balance 137 and limit 136 indicate that subscriber 170 has used very little of its allocation of shadow balance 140. Real balance 145 is also mostly unused, as indicated by relative sizes of maximum 141 and available balance amount 142.

As mentioned above, subscriber 175 has one real balance 150, and two shadow balances 155 and 160. Real balance 150 is about halfway used, as indicated by relative sizes of maximum 146 and available balance amount 147. For shadow balances 155 and 160, limit 151 and limit 156 are equal to one another. Subscriber 175 has used some of its limit 151 of shadow balance 155, as indicated by relative sizes of limit 151 and available balance amount 152, while shadow balance 420 is unused, as indicated by relative sizes of available balance amount 157 and limit 156.

Since shadow balances share a real balance, if one subscriber consumes all of the real balance, the other subscriber will not be permitted to make a further consumption from the real balance. For example, assume that subscriber 175 consumes all of real balance 110. Consequently, even if available balance amount 132 shows that subscriber 170 is permitted to make a further consumption from real balance 110, since real balance 110 is depleted, subscriber 170 cannot make the further consumption from real balance 110.

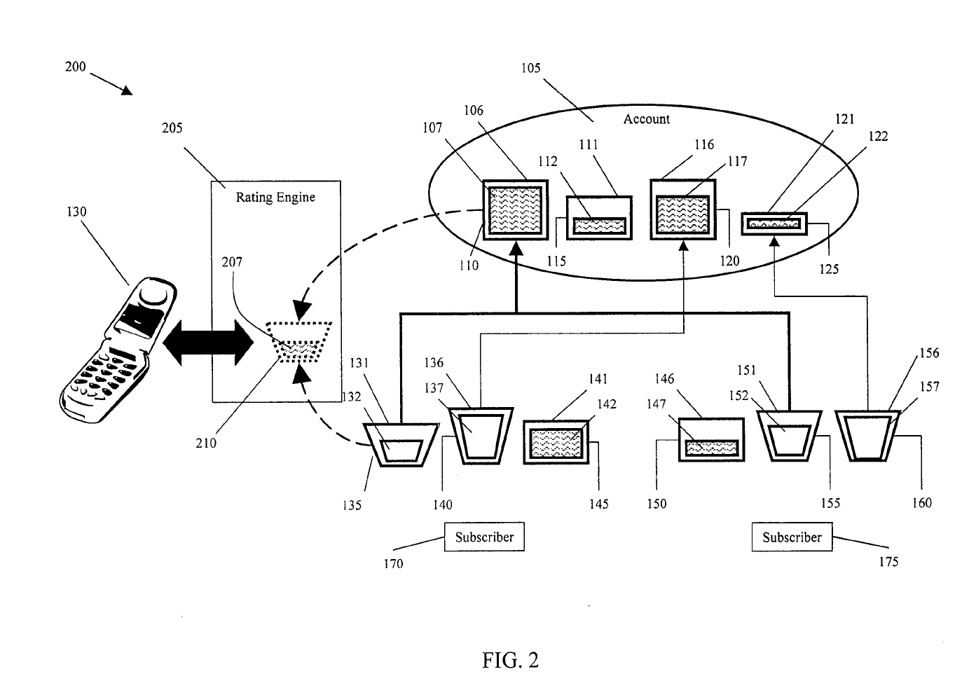

FIG. 2 is a block diagram of a configuration of balances, namely configuration 200, that is similar to configuration 100, but includes a rating engine 205.

Rating engine 205 calculates a virtual balance 210, i.e., a resultant balance, having a virtual available balance amount 207. Virtual available balance amount 207 is the minimum, i.e., smallest, of (a) available balance amount 107, i.e., the currently available amount of real balance 110, and (b) available balance amount 132, i.e., the currently available amount of shadow balance 135. Note that even though there are funds available in real balance 110, i.e., available amount balance 107, subscriber 170 is limited to only what is remaining in shadow balance 135, i.e., available balance amount 132. Thus, rating engine 205 determines which of available balance amount 107 and available balance amount 132 is smallest, and concludes that both of available balance amount 107 and available balance amount 132 are sufficient to provide for a service, if the smallest balance is sufficient to provide for the service.

As an example, assume that (i) account 105 has $30 in real balance 110, i.e., available balance amount 107 is $30, and (ii) subscriber 170 has a shadow balance 135 with a monthly limit 131 of $20/month, of which $10 is remaining, i.e., available balance amount 132 is $10. Virtual balance amount 207 would be $10, i.e., the smaller of available balance amount 107 and available balance amount 132. In this example, subscriber 170 would only be able to use $10, i.e., virtual available balance amount 207, of the $30, i.e., available balance amount 107, shared for any particular activity.

Note that rating engine 205 is presented with a single view of shadow balance 135 (for subscriber 170). For example, rating engine 205 does not need to consider that shadow balance 155 (for subscriber 175) is also associated with real balance 110, and that shadow balances 135 and 155 thereby share real balance 110. This concept of a single view divorces from calculations within rating engine 205 any knowledge about how shadow balances may share in a real balance, various limit values, etc. By presenting this single view to rating engine 205, rating engine 205 is able to provide balance sharing, e.g., real balance 110 being shared by shadow balance 135 and shadow balance 155, and control of how much each subscriber 170 and 175 consumes from real balance 110, without additional complexities being introduced into the implementation of rating engine 205.

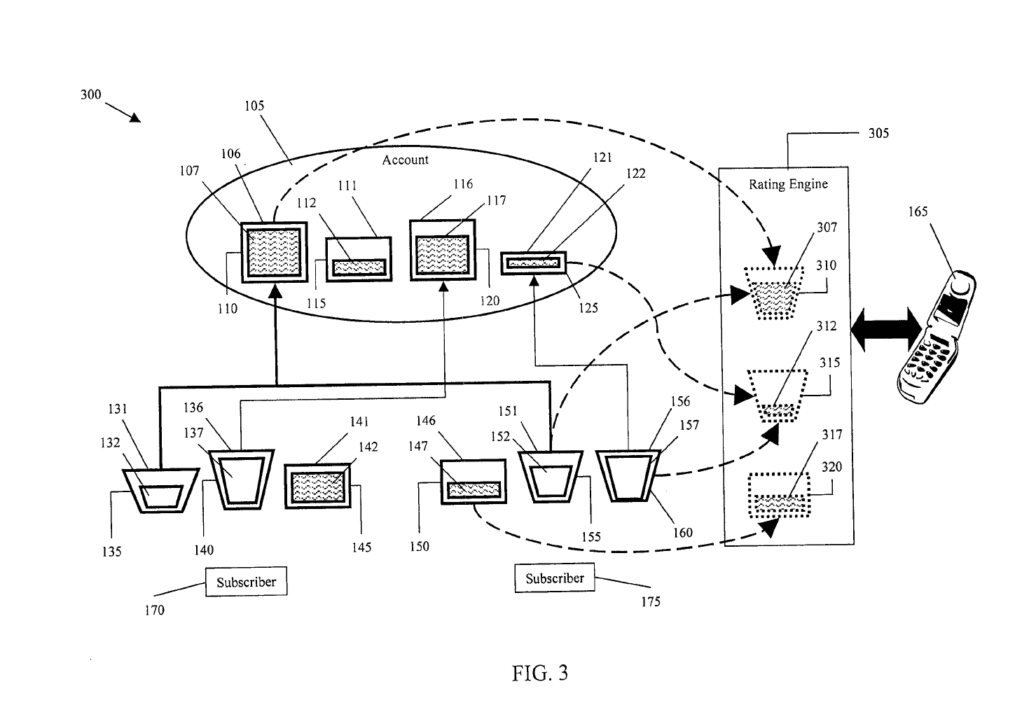

FIG. 3 is block diagram of a configuration of balances, namely configuration 300, and shows a further illustration of a rating process for shadow balances. In configuration 300, a rating engine 305 calculates (i) a virtual balance 310 having a virtual available balance amount 307 and (ii) a virtual balance 315 having a virtual available balance amount 312. Virtual available balance amount 307 is the minimum, i.e., smallest, of available balance amount 107 and available balance amount 152. Virtual available balance amount 312 is the minimum, i.e., smallest, of available balance amount 122 and available balance amount 157.

Rating engine 305 also calculates a real balance 320 having an available balance amount 317, which is, in essence, a copy of real balance 150 and available balance amount 147, respectively. Of note here is that rating engine 305 can use real balances and shadow balances in any combination. Any single charge may span multiple balances, depending on the service provider's configuration. For example, a data plan may be paid off in either usage units, e.g., bytes, or in currency. If a subscriber has a plan in which they have a bytes balance with 50 Kb remaining, and any excess usage is paid at $0.10/Kb, then a usage of 80 Kb would be charged 50 Kb to the bytes balance, and $3 to the currency balance (80 Kb−50 Kb)*($0.10/Kb). By using multiple balances, the rating engine may also use multiple balance types, e.g., the bytes balance is a shadow balance, but the currency balance is a real balance.

Note that subscriber 175 has plenty of available capacity in shadow balance 160 (indicated by the relative positions of available balance amount 157 and limit 156), yet the account balance itself has insufficient funds (as indicated by available amount 122). A more concrete example of this type of scenario would be a small business account for a sales team, where each salesperson could spend up to $500/quarter of the department's shared funds. When Mary attempts to use data services, she may be denied service even though she has not spent $500 this quarter, because the department's balances are under-funded. This relates back to the concept of guaranteed sharing, where the subscribers are not permitted to spend more money via their shadow balances than the account has available.

Each of FIGS. 1-3 shows shadowing of subscriber balances to an account within the same hierarchy. For example, in FIG. 1, all of the balances represented in configuration 100 are subordinate balances of a common account, i.e., account 105. Note however, that it is quite possible to shadow to different balances in other hierarchies, permitting sharing or funding outside normal account relationships. For example, John pays for his friend's SMS messages, even though they each have their own independent accounts.

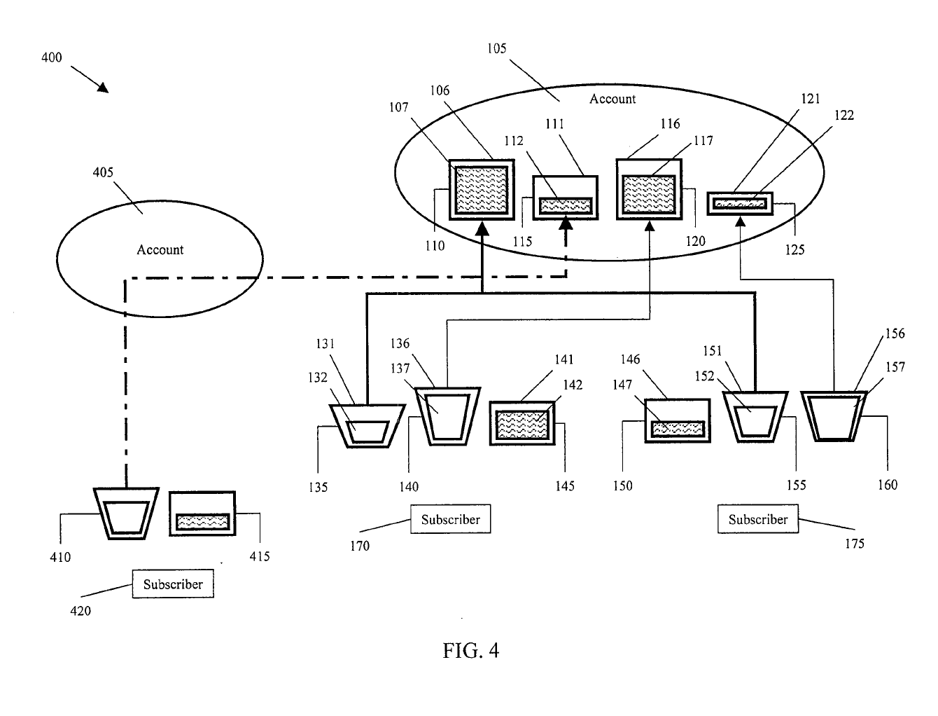

FIG. 4 is a block diagram of a configuration of balances, namely configuration 400, involving a plurality of accounts, i.e., account 105 and an account 405. Account 405 consists of a single subscriber, i.e., a subscriber 420. Subscriber 420 has a shadow balance 410 and a real balance 415. Although subscriber 420 is a member of account 405, shadow balance 410 is associated with real balance 115 of account 105. As a result of this configuration, subscriber 420 is able to consume funds from account 105, which is outside subscriber 420's account hierarchy.

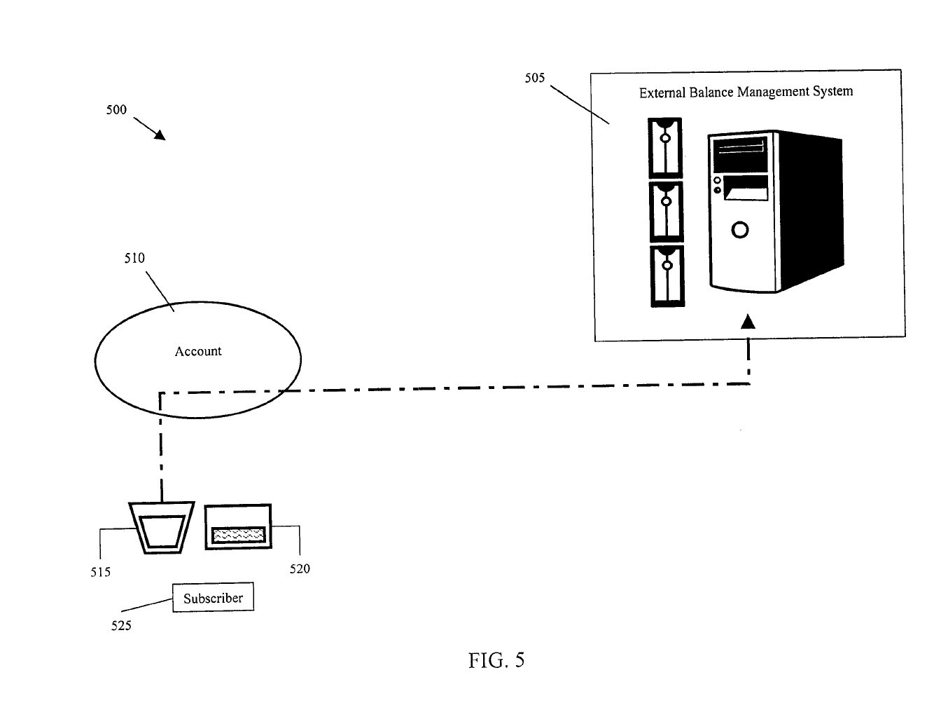

FIG. 5 is a block diagram of a configuration of balances, namely configuration 500, associated with a system that is outside of a domain of the service provider. An account 510 consists of a single subscriber, i.e., a subscriber 525. Subscriber 525 has a shadow balance 515 and a real balance 520. Shadow balance 515 is associated with an external balance management system 505. Thus, subscriber 525 is able to consume funds that are stored and represented outside of a domain of the service provider of account 510.

For example, it is possible that during integration of a service provider's business software systems, separate systems (from different vendors) provide the rating capability and the balance management capability (at least in part). For example, vendor A provides a system that manages accounts funded by cash payments within a retail network. Vendor B provides the shadow balance capability as part of vendor B's rating system. The service provider may wish to have subscribers on vendor B's system, e.g., mobile accounts, have their services paid for out of the balances managed by vendor A's cash management system.

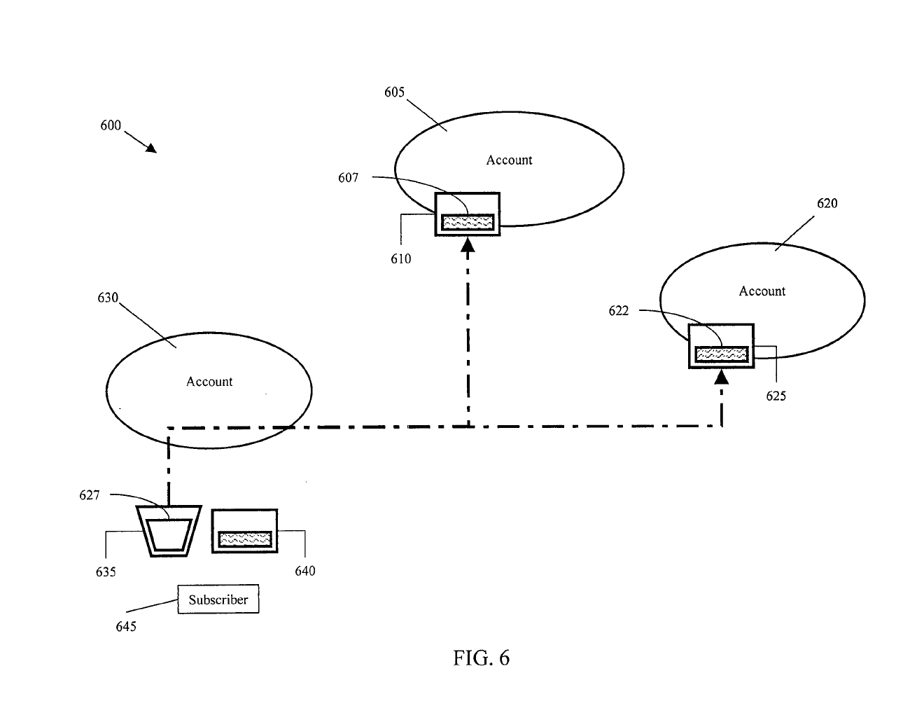

FIG. 6 is a block diagram of a configuration of balances, namely configuration 600, in which a shadow balance is associated with a plurality of real balances in different accounts. An account 630 is configured with a single subscriber, i.e., a subscriber 630. Subscriber 630 has shadow balance 635 and real balance 640. Shadow balance 635 is associated with (i) a real balance 610 in an account 605, and (ii) a real balance 625 in an account 620. Real balance 610 has an available balance amount 607, and real balance 625 has an available balance amount 622. Accounts 605 and 620 may also have their own subscribers (not shown) with their own shadow balances (not shown). Shadow balance 635 is a subordinate balance of account 630, while real balance 610 is a subordinate balance of account 605, and real balance 625 is a subordinate balance of account 620.

By configuring multiple shadow balance targets, i.e., real balances 610 and 625, for the same shadow balance 635, subscriber 645 is able to consume from multiple sources of funds as part of a single transaction. In effect, a net real available balance amount is a sum of available balance amount 607 and available balance amount 622. The fact that subscriber 645 may use, via shadow balance 635, funds from each of real balances 610 and 625 is based on a service agreement for each of accounts 630, 605 and 620.

Recall that during a rating operation, a rating engine calculates a virtual available balance amount that is a minimum, i.e., smallest, of (a) an available balance amount in a real balance and (b) an available balance amount in a shadow balance. For example, see FIG. 2, rating engine 205. Similarly, subscriber 645 can only consume from real balances 610 and 625 if (i) shadow balance 635 has a sufficient available amount balance 627, and (ii) the sum of available amount balances 607 and 622 is non-zero. Note that real balances 610 and 625 will have the same unit type, e.g., dollars.

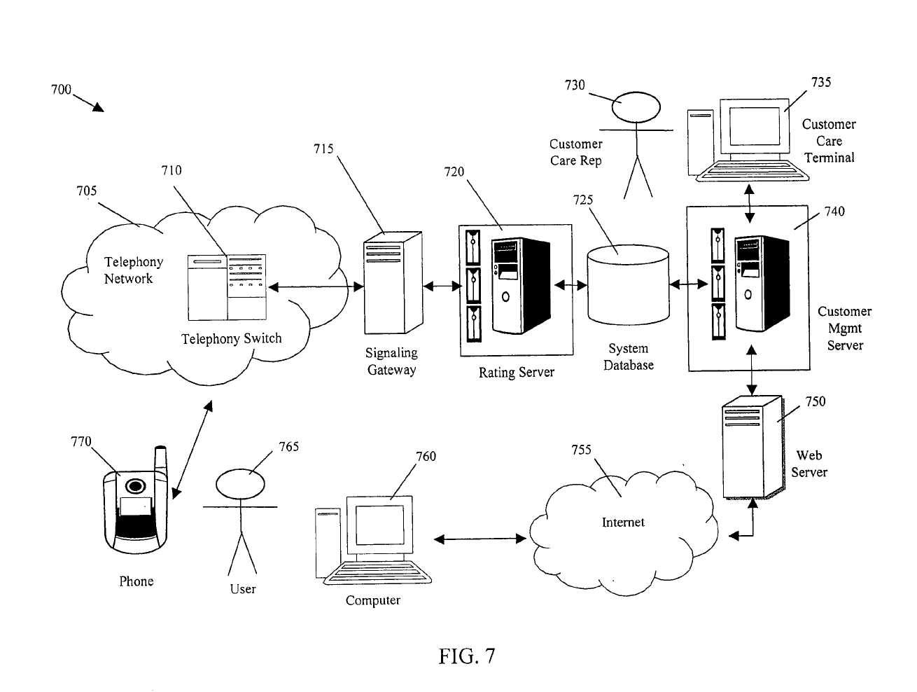

FIG. 7 is a block diagram of a communication system 700 that includes a server, i.e., a rating server 720, for administrating shadow balances. Communications system 700 includes a telephony network 705, a signaling gateway 715, rating server 720, a system database 725, a customer management server 740, and a customer care terminal 735. Communications system 700 also includes a web server 750 coupled to the Internet 755.

A user 765, i.e., a subscriber, purchases a mobile handset 770 from a mobile service provider (not shown). Handset 770 communicates via a mobile telephony network, i.e., telephony network 705, which includes a telephony switch 710.

Telephony switch 710 is configured to notify signaling gateway 715 of any network events related to subscribers represented on system database 725. For example, call offered, call answered, and call disconnected are three types of events for which signaling gateway 715 would receive notification. Signaling gateway 715, in turn, passes events to rating server 720.

Rating Server 720 implements techniques for administrating shadow balances, as shown in FIGS. 1-6. In this regard, rating server 720 runs software that, among other rating calculations, manages shadow balances, and factors shadow balances into its calculations. As a result of these calculations, rating server 720 communicates back through signaling gateway 715 to telephony switch 710, advising of conditions on user 765's account that may limit user 765's activities, such as a low balance condition.

Telephony switch 710 acts on advice from rating server 720 and affects user 765's call, either by disconnecting, denying or changing the quality of service. This scenario describes a real-time rating and authorization capability, where usage is allowed or denied based on calculations that are performed in sequence with the network events.

As charges for usage are calculated and applied, system database 725 is updated accordingly. Customer management server 740 is connected to system database 725 and provides administrative capabilities to clients such as customer care terminal 735 and web server 750. A customer service representative 730 can use customer care terminal 735 to inform user 765 about details of user 765's account, and make any changes at user 765's request. User 765 can also manage their own account through a computer 760, e.g., a personal computer, which is connected through the Internet 755 to web server 750.

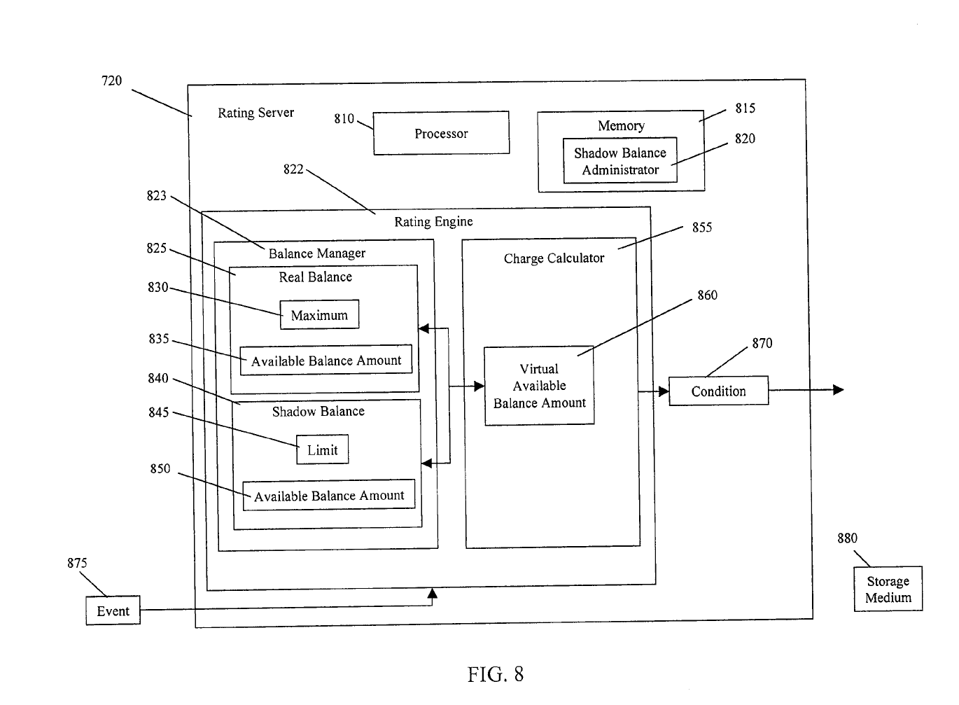

FIG. 8 is a block diagram of rating server 720. Rating server 720 includes a processor 810 and a memory 815. Memory 815, in turn, includes a shadow balance administrator 820, that contains instructions that are readable by processor 810 to cause processor 810 to perform the activities described in the context of FIGS. 1-7, and further described below.

Processor 810, pursuant to the instructions in shadow balance administrator 820, implements a rating engine 822 that includes a balance manager 823 and a charge calculator 855. Processor 810, via balance manager 823, maintains a real balance 825, and maintains a shadow balance 840 for subscriber 765. Processor 810 also performs rating calculations within charge calculator 855. Real balance 825 has a maximum 830 and an available balance amount 835. Shadow balance 840 has a limit 845 and an available balance amount 850. Shadow balance 840 is associated with real balance 825.

Rating engine 822 receives a communication, i.e., event 875, indicative of an event concerning a call being made by subscriber 765 (e.g., call offered, call answered, or call disconnected). Rating engine 822, via balance manager 823, evaluates real balance 825 and shadow balance 840, and calculates a virtual available balance amount 860. Virtual available balance amount 860 is the minimum, i.e., smallest, of available balance amount 835 and available balance amount 850. Rating engine 855, based on its evaluation of real balance 825 and shadow balance 840, and in particular its calculation of virtual available balance amount 860, performs rating calculations within charge calculator 855, and outputs a communication, i.e., a condition 870, indicative of a condition of user 765's account.

Condition 870 is communicated through signaling gateway 715 to telephony switch 710. Telephony switch 710 acts on condition 870 and affects user 765's call, for example by permitting, disconnecting, denying or changing the quality of service.

As the call progresses, rating engine 822 receives information about the call, e.g., duration of call, via a subsequent event 875 communication, and accordingly, updates available balance amount 835 and available balance amount 850 via balance manager 823 based on charges calculated using charge calculator 855. If necessary, rating engine 822 issues a subsequent condition 870.

Thus, processor 810, pursuant to instructions in shadow balance administrator 820, performs actions of (a) obtaining a first balance, e.g., available balance amount 850, indicative of a first available funding for a service for subscriber 765, in which the first balance may be consumed by subscriber 765; (b) obtaining a second balance, e.g., available balance amount 835, indicative of a second available funding for the service, in which the second balance may be consumed by subscriber 765; (c) determining whether both of the first and second balances are sufficient to provide for the service; and (d) issuing a communication, e.g., condition 870, to a device, e.g., telephony switch 710, to permit usage of the service by the subscriber, if both of the first and second balances are sufficient to provide for the service.

Rating server 720 may be implemented in a general-purpose computer, in which case, shadow balance administrator 820 may be implemented in software as a program module. The term “module” is used herein to denote a functional operation that may be embodied either as a stand-alone component or as an integrated configuration of a plurality of sub-ordinate components. Alternatively, rating server 720 may be implemented as an application-specific device in hardware or firmware, or a combination thereof.

Although shadow balance administrator 820 is shown herein as being installed in memory 815, shadow balance administrator 820 can be tangibly embodied on an external computer-readable storage medium 880 for subsequent loading into memory 815. Storage medium 880 can be any conventional storage medium, including, but not limited to, a floppy disk, a compact disk, a magnetic tape, a read only memory, or an optical storage medium. Shadow balance administrator 820 could also be embodied in a random access memory, or other type of electronic storage, located on a remote storage system and coupled to memory 815.

Also, although real balance 825 is shown as being maintained within rating server 720, real balance 825 could be maintained on external balance management system 505 (see FIG. 5).

The technical benefits of shadow balances lie in the way that the association of the balances and the respective balance limits is disassociated from the actual rating calculations. Using the concept of a “virtual” balance, the attributes of the shadow balance and the real balance are combined into a single entity for purposes of rating calculations.

The use of shadow balances provides service providers with the ability to configure flexible and attractive packages for their customers. In particular, the service provider may now offer plans with shared funds amongst different entities, and be able to guarantee that this sharing does not exceed the fund's capacity. This provides variety for the service provider, allowing them to offer more attractive packages to their customers, while at the same time limiting the service provider's exposure to revenue loss.

Sharing may allow customers to pay for services using a combination of local (their own) and remote (other customers') balances. Again this provides variety to the customer both within and outside of any normal billing relationship. This can allow customers to “sponsor” other customers' activity. For example, see configuration 600 in FIG. 6.

Sharing may cross object types (e.g., prepaid, postpaid, online, offline), again providing variety by permitting various combinations of sharing and sponsoring. For example, a postpaid business account might sponsor the usage (by providing a shared balance) to a contractor's personal prepaid account.

Shadow balances provide the service provider with a simple form of sharing versus a full liability redirection, which carries more of a financial responsibility for the parties. While John may sponsor his friend's SMS usage by providing a shared balance, John will not be financially responsible if John's friend does not pay his bills.

The service provider may specify the order in which balances are used. That is, a customer could consume shared balances first, last, or mixed in with real balances. For example, in FIG. 3, virtual balances 310 and 315 and real balance 320 may be charged in any order, depending upon configuration. The service provider may configure an order in which real balance 320 is consumed first, and then virtual balances 310 and 315 thereafter, or conversely virtual balances 310 and 315 may be used first, with real balance 320 being used last. Multiple balances are only used whenever there are insufficient funds in one or more balances to pay for the entire usage. For example, if available balance amounts 307, 312 and 317 have values $1, $1 and $2 respectively, and the usage is rated for a total charge of $3, and the configured balance order is virtual balance 310, virtual balance 315, and real balance 320, then $1 will be charged to each of virtual balance 310, virtual balance 315, and real balance 320 and deducted from available balance amounts 307, 312 and 317.

The service provider may also control the spending of the shared funds at an individual level, allowing full customization. This allows the service provider to tailor individual plans for each customer. This type of personalization is very attractive to customers and promotes retention and new customer acquisition.

Use of shadow balances permits customers to tailor their own plans to meet their unique needs. A family may allocate higher spending limits to the parents versus the children. Parents may opt to increase a child's monthly limit as a reward for good grades or behavior. A small business may allow different spending limits for members of its sales force (who make more international calls) than members of its development staff.

The service provider can limit which balances can be shared and for which activities. Service providers may allow sharing of local minutes, but may not for international calls. This minimizes the service provider's exposure for revenue loss by controlling who pays for high-value services.

Although FIGS. 1-8 are described in the context of a mobile telephone communication service, the techniques described herein are not limited as such, but instead could be employed in the context of other services, such as a data communication service. Another exemplary service is a credit transaction. For example, assume two members of a sales department each have a credit card with an individual spending limit, and together a shared limit. Accordingly, for an attempted credit transaction, a rating server similar to rating server 720 would be employed to control a device to permit, deny or otherwise limit the credit transaction.

The techniques described herein are exemplary, and should not be construed as implying any particular limitation on the present invention. Also, steps associated with the processes described herein can be performed in any order, unless otherwise specified or dictated by the steps themselves. It should be understood that various alternatives, combinations and modifications could be devised by those skilled in the art. The present invention is intended to embrace all such alternatives, modifications and variances that fall within the scope of the appended claims.

TABLE 1

| Term | Definition |
|---|---|
| Account | An entity that represents a customer of a service provider. An |
| | account can be billable (for example, the liable party that owns |
| | the accounts receivable) or non-billable. An account contains |
| | the subscriber profile details and can have associated subscribers |
| | and offers. An account can have one or more child accounts |
| | (organized in a hierarchy), as well as one or more subscribers |
| | and offers. An account can have zero or one account bundle. |
| | Accounts can have real-time balances and accumulators. |
| Award | A rule that applies a monetary amount or non-monetary units to |
| | a balance. Sources for awards include voucher purchases, |
| | recharges, recurring charges, and bonus plans. The award is |
| | consumed in real time, through usage that occurs after the award |
| | has been granted. See also bonus. |
| Balance | A balance is a collection of funds of a similar unit type. |
| | Balances can be either (1) running (real-time authorization) |
| | balances or (2) financial (accounts receivable) balances. A |
| | balance is a representation of either a monetary or non-monetary |
| | (units-based) amount. A balance can be either postpaid or |
| | prepaid. A postpaid balance can signify a unit amount, a |
| | monetary credit, a spending limit, or the total amount due; all of |
| | which are incremented based upon user consumption activity. A |
| | real-time prepaid balance can represent the reserved holding of |
| | funds or units drawn from when a user consumes services. |
| Balance Order | The order in which usage, recurring, and non-recurring charges |
| | are applied to the balances associated with the subscriber and |
| | accounts |
| Bonus | A promotion scheme that rewards a subscriber with discounts or |
| | awards based upon specific subscriber characteristics or upon |
| | achieving a certain threshold level of usage. See also award. |
| Charging | The process of modifying balances based on the calculated |
| | amounts for recurring charge terms, non-recurring terms, and |
| | usage. |
| Credit Limit | A service provider-defined, cyclical balance limit, used to limit |
| | exposure on a postpaid balance. On a periodic basis, the balance |
| | is reset to this limit. If a balance reaches its minimum value |
| | (usually 0) during a cycle, then that balance cannot be used to |
| | authorize events until it is reset to the limit value at the start of |
| | the next cycle. Exemplary cycles include Daily, Weekly, |
| | Monthly, Quarterly, Yearly, Bill Cycle, and None. |
| Customer Care | The graphical user interface used to create and manage accounts, |
| Interface | subscribers, and hierarchies. |
| Invoice | Cyclically generated or on-demand detailed listing of charges, |
| | taxes, and outstanding balance against an account, associated |
| | discounts or credits, and adjustments. Also includes invoice |
| | number, invoice date, total amount, and so on. Invoices can be |
| | generated and formatted for dispatch to customers. |
| Offer | An offer is a minimum sellable entity that can be delivered to an |
| | account or subscriber for the consumption of service. It is a |
| | collection of reusable building blocks that models its activity |
| | usage type, service, price, eligibility, and dependencies with |
| | other offers, correlated resources, service payments, and |
| | consumed credits. Common types of offers are primary offer, |
| | supplementary offer, and account offer. |
| Payment | A payment is the transfer of money from one party (such as a |
| | person or company) to another. A payment is usually made in |
| | exchange for the provision of goods, services or both, e.g., |
| | transfer of money from subscriber to communication service |
| | provider in exchange for the services and goods offered. |
| Payment Mode | Payment mode refers to the mode in which the subscriber makes |
| | payment to the communications service provider. Payment can |
| | be made in Prepaid Mode or Postpaid mode. |
| Postpaid Balance | A postpaid balance signifies a unit amount, a monetary credit, a |
| | spending limit, or the total amount due; all of which are |
| | incremented based upon user consumption activity. |
| Postpaid Payment | Postpaid Payment mode refers to services paid for after use, i.e., |
| Mode | use and pay. |
| Prepaid Balance | A prepaid balance represents the reserved holding of funds or |
| | units drawn from when a user consumes services. |
| Prepaid Payment | Prepaid Payment mode refers to services paid for in advance, |
| Mode | i.e., pay and then use. |
| Product Catalog | The Product Catalog is a system-provisioning data store for |
| | coherent and centralized management of market offerings. It |
| | supports multiple virtual service provider product definitions |
| | within a deployment and provides various paradigms for market |
| | segmentation and product pricing. |
| Real Time | Describes an activity or transaction that occurs during the rating |
| | and/or charging process, as opposed to waiting until the end of a |
| | cycle (bill time). Note that the “real-time” rating and/or |
| | charging process takes place, in most cases, during the actual |
| | duration of the usage event that is being rated and/or charged. |
| Recurring/Non- | The entity that generates recurring and non-recurring charges |
| Recurring Charge | and applies them to subscriber balances. |
| Server | |
| Spending Limit | A user-definable (account-definable) cyclical limit on a balance, |
| | put in place to voluntarily control spending on a balance. A |
| | spending limit is used to limit exposure on a postpaid balance. |
| | Spending limits are reset cyclically and are not impacted by |
| | payments. |
| Statement | Cyclically generated or on-demand detailed listing of charges, |
| | taxes, and remaining balance against an account, associated |
| | discounts or and credits. Also includes statement number, |
| | statement date, statement amount, and so on. Statement can be |
| | generated and formatted for dispatch to customers. |
| Subscriber | Subscriber refers to: (a) A person who uses the product or |
| | service (b) A specific service-delivery point for a product or |
| | service, for example, a telephone line, a login account for an |
| | online service, an end point in a leased line network. |
| Unified Rating | Unified Rating Engine enables service providers to charge for all |
| Engine | telecom services in real time and non-real-time, with complete |
| | real-time balance management for prepaid, postpaid, and hybrid |
| | customers. It has a flexible charging model that can adapt to |
| | evolving customer models with the ability to limit overall |
| | customer liabilities for reduced financial risk. It enables real- |
| | time and deferred promotions, with cross-product discounting to |
| | create innovative marketing offers for penetrating new customer |
| | segments and reducing churn. It supports many rating features |
| | to meet a wide range of requirements from the wireline, mobile, |
| | cable, and Internet broadband industries. |

What is claimed is:

1. A method comprising:
obtaining a first balance indicative of a first available funding for a service for a subscriber, wherein said first balance may be consumed by said subscriber;
obtaining a second balance indicative of a second available funding for said service, wherein said second balance may be consumed by said subscriber;
determining whether both of said first and second balances are sufficient to provide for said service; and
issuing a communication to a device to permit usage of said service by said subscriber, if both of said first and second balances are sufficient to provide for said service.

2. The method of claim 1, wherein said second balance may be consumed by either of said subscriber or another subscriber.

3. The method of claim 1, wherein said determining comprises:
determining which of said first balance and said second balance is a smallest balance; and
concluding that both of said first and second balances are sufficient to provide for said service, if said smallest balance is sufficient to provide for said service.

4. The method of claim 1, wherein said first and second balances are subordinate balances of a common account for funding for said service.

5. The method of claim 1,
wherein said first balance is a subordinate balance of a first account for funding for said service, and
wherein said second balance is a subordinate balance of a second account for funding for said service.

6. The method of claim 1, wherein said second balance is a sum of balances from a plurality of sources for funding for said service.

7. The method of claim 1, wherein said service is selected from the group consisting of a telephone communication service, a data communication service, and a credit transaction.

8. A system comprising:
a processor; and
a memory that contains instructions that control said processor to cause said processor to perform actions of:
obtaining a first balance indicative of a first available funding for a service for a subscriber, wherein said first balance may be consumed by said subscriber;
obtaining a second balance indicative of a second available funding for said service, wherein said second balance may be consumed by said subscriber;
determining whether both of said first and second balances are sufficient to provide for said service; and
issuing a communication to a device to permit usage of said service by said subscriber, if both of said first and second balances are sufficient to provide for said service.

9. The system of claim 8, wherein said second balance may be consumed by either of said subscriber or another subscriber.

10. The system of claim 8, wherein said determining comprises:
determining which of said first balance and said second balance is a smallest balance; and
concluding that both of said first and second balances are sufficient to provide for said service, if said smallest balance is sufficient to provide for said service.

11. The system of claim 8, wherein said first and second balances are subordinate balances of a common account for funding for said service.

12. The system of claim 8,
wherein said first balance is a subordinate balance of a first account for funding for said service, and
wherein said second balance is a subordinate balance of a second account for funding for said service.

13. The system of claim 8, wherein said second balance is a sum of balances from a plurality of sources for funding for said service.

14. The system of claim 8, wherein said service is selected from the group consisting of a telephone communication service, a data communication service, and a credit transaction.

15. A storage medium comprising instructions tangibly embodied thereon, wherein said instructions are readable by a processor, and cause said processor to perform actions of:
obtaining a first balance indicative of a first available funding for a service for a subscriber, wherein said first balance may be consumed by said subscriber;
obtaining a second balance indicative of a second available funding for said service, wherein said second balance may be consumed by said subscriber;
determining whether both of said first and second balances are sufficient to provide for said service; and
issuing a communication to a device to permit usage of said service by said subscriber, if both of said first and second balances are sufficient to provide for said service.

16. The storage medium of claim 15, wherein said second balance may be consumed by either of said subscriber or another subscriber.

17. The storage medium of claim 15, wherein said determining comprises:
determining which of said first balance and said second balance is a smallest balance; and
concluding that both of said first and second balances are sufficient to provide for said service, if said smallest balance is sufficient to provide for said service.

18. The storage medium of claim 15, wherein said first and second balances are subordinate balances of a common account for funding for said service.

19. The storage medium of claim 15,
wherein said first balance is a subordinate balance of a first account for funding for said service, and
wherein said second balance is a subordinate balance of a second account for funding for said service.

20. The storage medium of claim 15, wherein said second balance is a sum of balances from a plurality of sources for funding for said service.

21. The storage medium of claim 15, wherein said service is selected from the group consisting of a telephone communication service, a data communication service, and a credit transaction.
